(19) United States
(12) Patent Application Publication
(10) Pub. No.: US 2007/0000904 A1
(43) Pub. Date: Jan. 4, 2007

(54) Industrial tunnel type wood burning oven for the baking of pizza and similar alimentary products

(76) Inventor: Pietro Ferro, Brebbia ( VA) (IT)

Correspondence Address: JACOBSON HOLMAN PLLC, 400 SEVENTH STREET N.W., SUITE 600, WASHINGTON, DC, 20004, US

(21) Appl. No.: 11/150,302

(22) Filed: Jun. 13, 2005

(30) Foreign Application Priority Data
May 23, 2005 (IT) MI2005A 000934

(51) Int. Cl. F27B 9/06; F27D 11/00

(52) U.S. Cl. 219/388

(57) ABSTRACT

An industrial oven with tunnel for the baking of pizza or similar alimentary products is shown, made up of a bearing structure (10) in refractory material comprising an inlet mouth (40) and one of outlet (41) connected by a passing through tunnel (4) along which a baking surface (5) supporting pizza or similar alimentary products slides. Said oven is heated with firewood and it comprises slits (22, 24) for the passage of primary air for the combustion of the firewood and air for the oxidation of the excess smoke, said primary and secondary air being moved by fans (50) controlled by a control unit which processes data on the composition of the air detected inside the oven by sensors (26), a top combustion chamber (15) housing top furnaces (17) made up of top grates (18) supporting combustible firewood and a bottom combustion chamber (16) housing bottom furnaces (30) made up of bottom grates (31) supporting combustible firewood.

The present invention concerns an industrial tunnel type wood burning oven for the baking of pizza and similar alimentary products.

Pizza is one of the most widespread foods in the world. Not all over the world however pizza has a taste that approaches the one produced in Italy according to traditional methodologies typical of the Italian cuisine.

Classic Italian pizza houses produce pizza in wood burning ovens whose dimensions do not allow a high productivity. Bigger pizza houses have two ovens which however do not allow to bake more than 4-5 pizza pies each.

In order to produce pizza industrially gas heated tunnel type ovens are used, that are made up of a bearing structure of refractory material with a through tunnel.

A conveyor mean allows to move the pizza or similar alimentary product (for example “focaccia”) from an inlet mouth to an outlet one.

Said ovens are heated by gas since the combustion of firewood is rather difficult to control in very long tunnels. An excess of smoke can cause the blackening of the pizza and the presence of incombustibles.

On the other hand gas heating does not allow to obtain good quality pizza. It is known that the most suitable ovens for baking the pizza are the ones using firewood.

Wood burning ovens are known that are made up of a revolving plate with a single inlet/outlet mouth for the pizza. Said plates can contain several pizza pies at the same time and they rotate intermittently in a single sense. The time necessary for the baking of the pizza, and therefore for the pizza to go back to the inlet/outlet mouth is calculated as a function of the baking temperature.

This last type of oven has the disadvantage to take up a lot of space. For each additional pizza that one wants to insert on the plate it is necessary to considerably increase the diameter of the latter.

By increasing the dimensions in addition there is again the inconveniency connected with the smoke which was mentioned for the tunnel type ovens.

In conclusion industrial gas heated tunnel type ovens allow a high productivity to the prejudice of the quality of pizza, whereas the ones with revolving plate (heated by firewood) allow to produce pizza pies having good quality but with limited productivity.

Object of the present invention is to provide an industrial oven for pizza or alimentary products which combines an optimum productivity with a good quality of the pizza, whose taste is at least comparable to the one made with common wood burning ovens of traditional pizza houses.

Additional object of the present invention is to provide a procedure for the baking of pizza or similar products in industrial ovens which allows the control of the temperature and the quality of the air on the baking surface.

According to the invention, such object is attained with an industrial oven with tunnel for the baking of pizza or similar alimentary products, made up of a bearing structure of refractory material comprising an inlet mouth and an outlet one connected by a passing through tunnel along which a baking surface supporting pizza or similar alimentary products slides, characterised in that it is heated by firewood.

Preferably the oven according to the invention comprises slits for the passage of primary air for the combustion of the firewood and of air for the oxidation of excess smoke, said primary and secondary air being moved by fans controlled by a control unit which processes data on the composition of the air detectable inside the oven by sensors, a top combustion chamber housing top furnaces made up of top grates supporting combustible firewood and a bottom combustion chamber housing bottom furnaces made up of bottom grates supporting combustible firewood.

The continuous monitoring of the baking surface and of the combustion chambers allows a regular and continuous baking of pizza. The control units serve as a real decision-making centre for the user, in particular for times and modalities of the charging of firewood. The intake of secondary air takes place automatically as a function of the data detected by the smoke sensors.

According to the invention, such additional object is attained with a procedure for the baking of pizza or similar alimentary products, characterised in that it provides the passage of the pizza or similar alimentary products through a tunnel type wood burning oven.

These and other characteristics of the present invention will be made more evident from the following detailed description of an embodiment thereof which is illustrated as a non-limiting example in the enclosed drawings, in which:

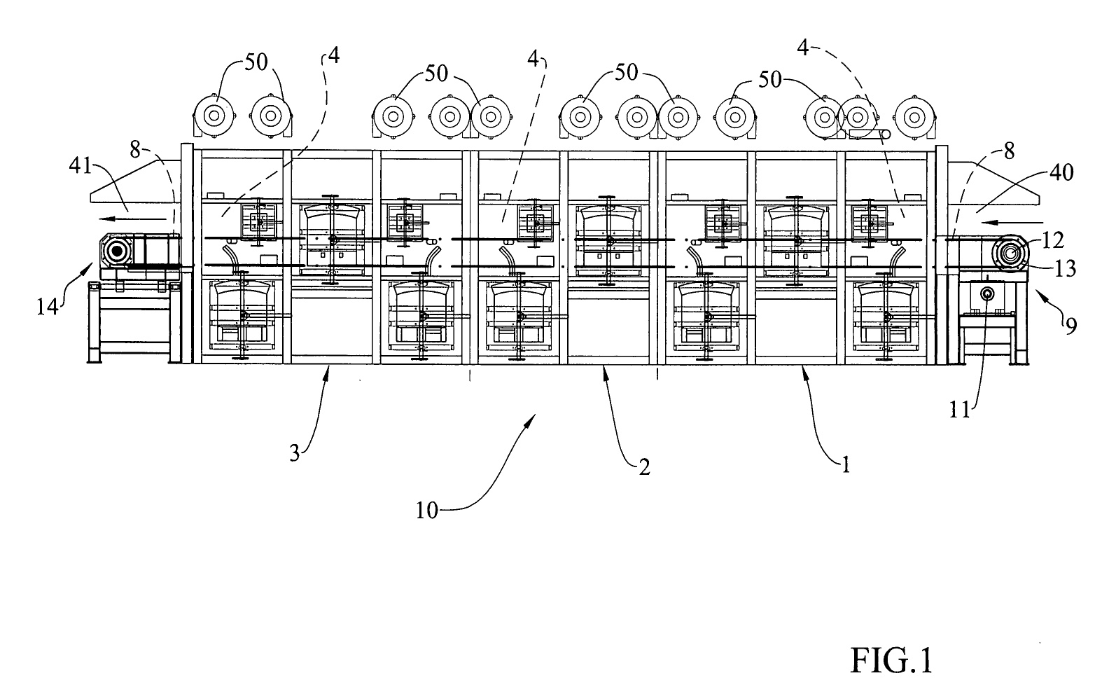

FIG. 1 shows a side view of an oven according to the present invention;

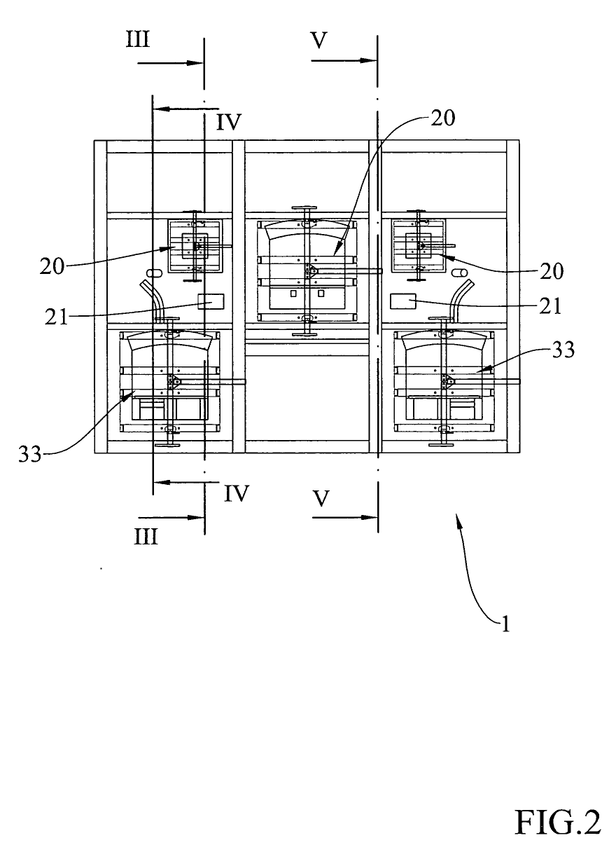

FIG. 2 shows a magnified side view of a portion of the oven in FIG. 1;

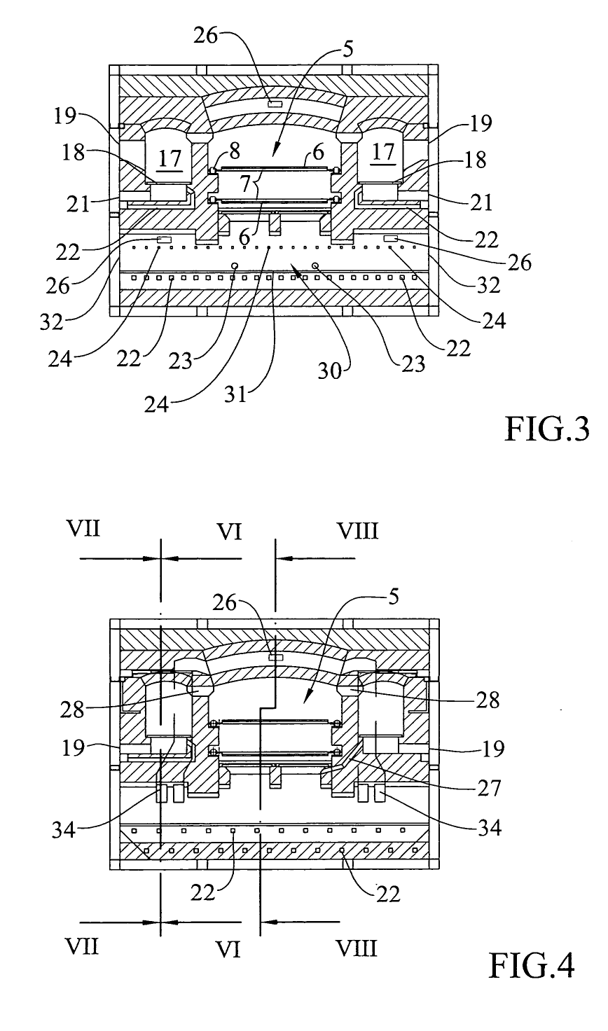

FIG. 3 shows a section view according to the line III-III in FIG. 2;

FIG. 4 shows a section view according to the line V-IV in FIG. 2;

FIG. 5 shows a section view according to the line V-V in FIG. 2;

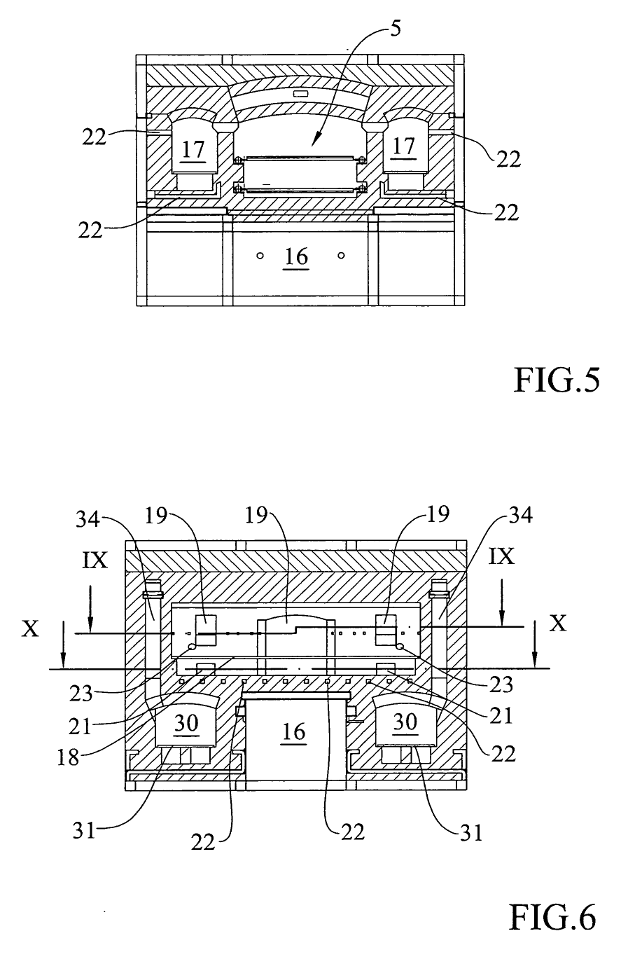

FIG. 6 shows a section view according to the line VI-VI in FIG. 4;

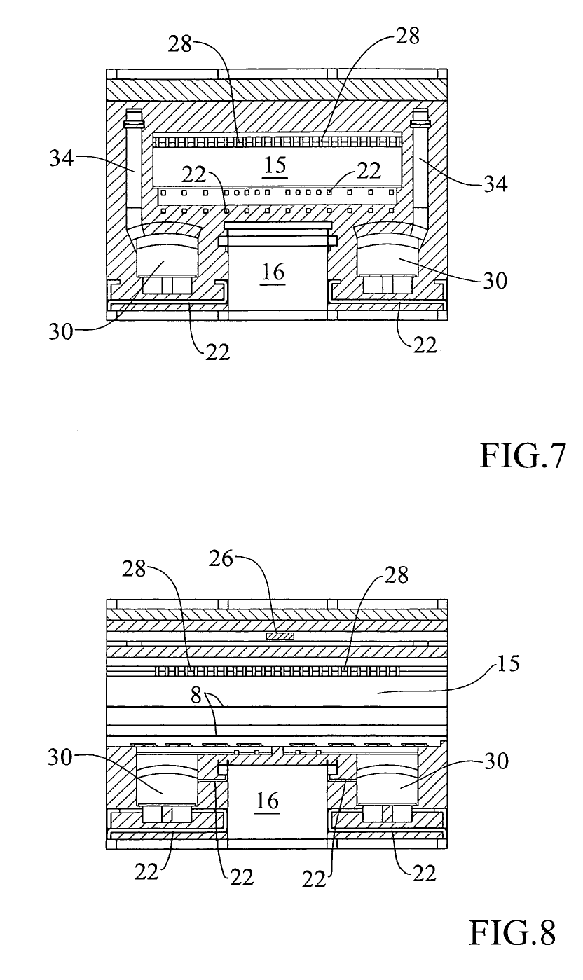

FIG. 7 shows a section view according to the line VII-VII in FIG. 4;

FIG. 8 shows a section view according to the line VIII-VIII in FIG. 4;

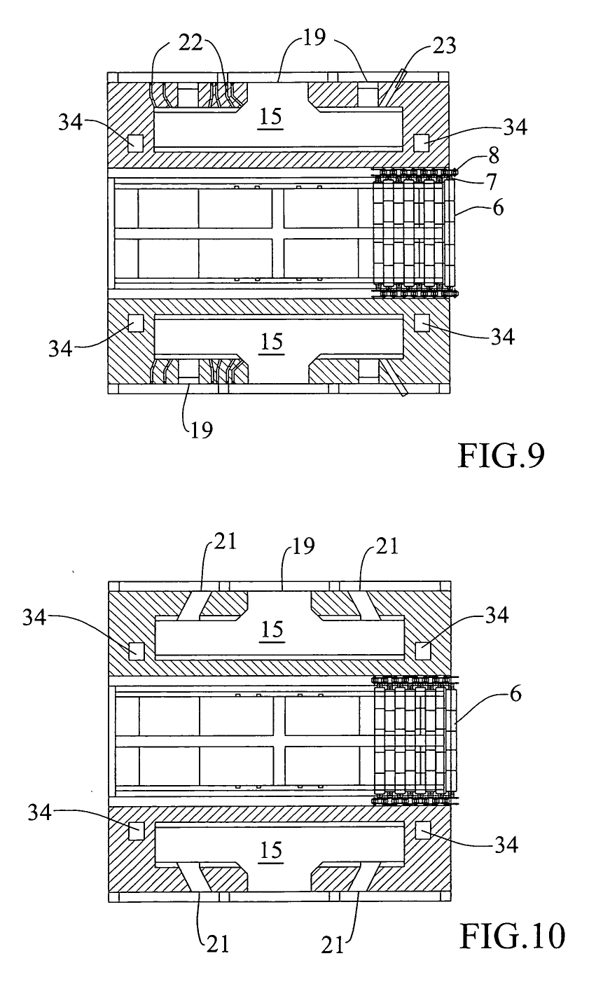

FIG. 9 shows a section view according to the line IX-IX in FIG. 6;

FIG. 10 shows a section view according to the line X-X in FIG. 6.

An industrial tunnel type wood burning oven according to the present invention is for example made up of a modular bearing structure 4 with through tunnel 10 comprising an inlet module 1 with inlet mouth 40, an intermediate module 2 and an outlet module 3 with outlet mouth 41, being the outlet module 3 equal to the inlet module 1 (FIG. 1).

The through tunnel 4 houses a mobile baking surface 5 made of refractory plates 6 mounted on steel brackets 7 whose ends are fastened to transport chains 8 controlled by a motor unit 9 (FIGS. 3-5, 9-10).

Said motor unit 9, located at the inlet of the tunnel 4, consists (FIG. 1) in a driving shaft 11 which through a transmission (not shown) controls a driven shaft 12 onto which a crown gear 13 is fastened which is engaged with the transport chain 8 kept in tension by a transmission unit 14 located at the outlet of the tunnel 4.

The bearing structure 10 comprises a top combustion chamber 15 and a bottom combustion chamber 16. The top combustion chamber 15 (FIGS. 3-10) comprises top furnaces 17 having top grates 18 onto which to lay combustible firewood (not shown) introducible through top openings 19 closed by top doors 20. Additional small openings 21 allow the partial cleaning of the top furnaces 17 (FIG. 2).

The bottom combustion chamber 16 (FIGS. 6-8) comprises bottom furnaces 30 having draught chimneys 34 and bottom grates 31 onto which to lay combustible firewood (not shown) introducible through bottom openings 32 closed by bottom doors 33.

Slits 22 allow the intake of primary air which supplies oxygen for the combustion of the firewood of the furnaces 17 and 30 ignited by gas burners (not shown) which are introduced and then withdrawn through round holes 23 (FIGS. 3 and 6).

Additional slits 24 allow the passage of secondary air pushed by fans 50 (FIG. 1) controlled by a control unit (not shown) which processes data coming from sensors of temperature and smoke 26.

Channels 27 (FIG. 4) allow the communication between the top furnaces 17 and the bottom ones 30, while openings 28 allow the communication between the top furnaces 17 and the baking surface 5.

As for what concerns the operation, in the first place the oven is brought to the temperature for the baking of the pizza by inletting primary air through the slits 22 and by igniting the furnaces 17 and 30 through the gas burners.

Once the chain 8 has been started by means of the motor unit 9, the pizza pies are laid one after the other on the baking surface 5 at the inlet mouth 40. The furnaces 17 determine the baking of the pizza pies.

The composition of the air and the temperature inside the oven are continuously monitored. The sensors 26 detect values which are sent to the control unit which compares them with reference values.

If the temperature inside the oven drops below a predefined limit, the control unit controls the charging of additional firewood that takes place manually. In addition the control unit is capable to establish where the firewood must be added. The door 20, 33 in which the charging of firewood must be done is in fact signalled to the worker.

If the sensors detect an excessive amount of smoke, the control unit orders the fans 50 the intake of secondary air through the slits 24, of which approximately 25% oxidizes the excess smoke which can blacken the pizza pies and produce incombustibles.

This monitoring system allows therefore to keep the baking conditions of the oven constant, thus guaranteeing a good quality of the pizza pies picked up at the outlet mouth 41 of the oven.

The length of the tunnel 4 is variable. The modular structure easily allows even in a second time to lengthen or shorten the oven according to the needs.

In a particular embodiment not shown in figures, said industrial wood burning oven can have a double heating mode, firewood and gas heating. As compared with the oven above described, the bottom combustion chamber can be heated with gas instead of firewood. The bottom combustion chamber is in fact used to heat the bearing structure of the oven and to maintain the refractory plates 6 in temperature along the distance back from the outlet to the inlet of the oven, whereas the top combustion chamber heats directly the baking surface.

The positive effects of the wood burning oven for the baking of pizza would therefore be maintained, while taking advantage of a gas heated bottom combustion chamber there would be lower servicing costs and less amount of smoke.

1. Industrial oven with tunnel for the baking of pizza or similar alimentary products, made up of a bearing structure (10) in refractory material comprising an inlet mouth (40) and one of outlet (41) connected by a passing through tunnel (4) along which a baking surface (5) supporting pizza or similar alimentary products slides, characterised in that it is heated with firewood.

2. Oven according to claim 1, characterised in that it comprises slits (22, 24) for the passage of primary air for the combustion of the firewood and air for the oxidation of the excess smoke, said primary and secondary air being moved by fans (50) controlled by a control unit which processes data on the composition of the air detected inside the oven by sensors (26), a top combustion chamber (15) housing top furnaces (17) made up of top grates (18) supporting combustible firewood and a bottom combustion chamber (16) housing bottom furnaces (30) made up of bottom grates (31) supporting combustible firewood.

3. Oven according to claim 2, characterised in that the percentage of secondary air which oxidizes the excess smoke is equal to approximately 25% of the one intaken into the oven.

4. Oven according to claim 2, characterised in that said top furnaces (17) are reachable through top openings (19) closed by top doors (20) whereas said bottom furnaces (30) are reachable through bottom openings (32) closed by bottom doors (33).

5. Oven according to claim 4, characterised in that it comprises additional top openings (21) for the cleaning of top the furnaces (17).

6. Oven according to claim 2, characterised in that said bottom combustion chamber (16) comprises draught chimneys (34).

7. Oven according to claim 1, characterised in that said mobile baking surface (5) consists in a series of adjacent refractory plates (6) mounted on steel brackets (7) whose ends are fastened to transport chains (8) controlled by a motor unit (9).

8. Oven according to claim 7, characterised in that said motor unit (9) consists in a driving shaft (11) which through a transmission controls a driven shaft (12) onto which a crown gear is fastened (13) which is engaged with the transport chain (8).

9. Oven according to claim 1, characterised in that said baking surface (5) consists in a conveyor belt.

10. Oven according to claim 1, characterised in that it comprises holes (23) for the passage of ignition means.

11. Oven according to claim 10, characterised in that said ignition means consist in gas burners.

12. Oven according to claim 1, characterised in that it comprises a top combustion chamber (15) housing top furnaces (17) made up of top grates (18) supporting combustible firewood and a bottom gas combustion chamber (16).

13. Oven according to claim 1, characterised in that said bearing structure (10) is made up of at least one module (1-3).

14. Oven according to claim 13, characterised in that said bearing structure (10) is made up of an inlet module (1), an outlet module (3) and at least one intermediate module (2).

15. Procedure for the baking of pizza or similar alimentary products, characterised in that it provides the passage of the pizza pies or similar alimentary products through a tunnel type wood burning oven.

16. Procedure according to claim 15, characterised in that said passage through the tunnel type wood burning oven takes place in presence of smoke control by means of intake of secondary air controlled as a function of the composition of the air inside the oven.
